(19) United States
(12) Patent Application Publication
(10) Pub. No.: US 2014/0299558 A1
(43) Pub. Date: Oct. 9, 2014

(54) WATER DECANTING BARREL

(71) Applicants: John Anthony Martz, Richmond, CA (US); Eric Troy Hemmingsen, San Pablo, CA (US); Jesus Oceguera, Hercules, CA (US)

(72) Inventors: John Anthony Martz, Richmond, CA (US); Eric Troy Hemmingsen, San Pablo, CA (US); Jesus Oceguera, Hercules, CA (US)

(73) Assignee: CHEVRON U.S.A. INC., San Ramon, CA (US)

(21) Appl. No.: 13/856,585

(22) Filed: Apr. 4, 2013

(51) Int. Cl. B01D 21/00

(52) U.S. Cl. CPC B01D 21/0018
USPC 210/800; 210/513

(57) ABSTRACT

Processes and apparatus for rapidly and efficiently removing liquid from a catalyst slurry comprising catalyst particles. A decanting barrel for dewatering the catalyst slurry may comprise a barrel body having a perforated portion, a reservoir in fluid communication with the perforated portion, and an evacuation conduit in fluid communication with the reservoir. In a process for removing the liquid from the catalyst slurry, the decanting barrel may be disposed in a container, the catalyst slurry may be added to the container, the liquid may be transferred from the catalyst slurry to the reservoir via the perforated portion of the barrel body, and the liquid may be removed from the reservoir via the evacuation conduit.

### FIELD

This invention relates to apparatus and processes for removing liquid from catalyst slurries.

### BACKGROUND

Solid catalysts used in reactors, such as refinery hydrocarbon hydroprocessing reactors, may eventually become inactivated or spent. The spent catalyst must be removed from the reactor for treatment and/or disposal in an appropriate manner. Typically, spent catalyst is removed from the reactor as an aqueous catalyst slurry.

In a conventional process for the separation of liquid and solid components of a catalyst slurry, an aliquot of the total volume of slurry from the reactor is disposed in a tank. An inclined auger is dipped into the slurry and the auger rotated, whereby solid components (catalyst) slowly move up the auger to allow separation of the catalyst from the slurry. An inclined semi-circular trough may be disposed substantially co-axially with, and beneath, the auger whereby liquid from the slurry may be returned to the tank. At the same time, liquid may be slowly pumped from the tank to allow for the gradual addition of further aliquots of the slurry. Such prior art processes are tedious, inefficient, expensive, and unreliable, for example, due to the nature of the process and the susceptibility of the equipment to mechanical failure.

There is a continuing need for improved apparatus and processes for the convenient and rapid removal of liquid from large volumes of spent catalyst slurry to provide convenient containment of both the liquid and the dewatered catalyst.

### SUMMARY

In one embodiment there is provided a process for removing a liquid from a catalyst slurry, the process comprising disposing a decanting barrel in a container, wherein the decanting barrel includes a barrel body having at least one perforated portion; adding the catalyst slurry to the container such that the catalyst slurry contacts the at least one perforated portion of the barrel body, wherein the catalyst slurry comprises the liquid and a plurality of catalyst particles; via the at least one perforated portion of the barrel body, transferring the liquid from the catalyst slurry to a reservoir of the decanting barrel; and removing the liquid from the reservoir in a proximal direction.

In another embodiment there is provided a process for removing a liquid from a catalyst slurry, the process comprising disposing a decanting barrel in a container, wherein the decanting barrel may include an evacuation conduit and a barrel body having at least one perforated portion; adding the catalyst slurry to the container, wherein the catalyst slurry may comprise the liquid and a plurality of catalyst particles; via the at least one perforated portion of the barrel body, transferring the liquid from the catalyst slurry to a reservoir of the decanting barrel; and pumping the liquid from the reservoir through the evacuation conduit. The reservoir may be disposed within the barrel body, the reservoir may be in fluid communication with the at least one perforated portion of the barrel body, and the evacuation conduit may be in fluid communication with the reservoir. The decanting barrel may further include a planar barrel base, and the evacuation conduit has a conduit distal end terminating at a location proximal to the barrel base. The step of adding the catalyst slurry to the container may comprise feeding the catalyst slurry to the container from a hydrocarbon hydroprocessing reactor, and the catalyst particles may comprise pellets of a hydrocarbon hydroprocessing catalyst. During the step of transferring the liquid from the catalyst slurry to the reservoir, the at least one perforated portion of the barrel body may be disposed upright in the container. The liquid transferring step and the liquid pumping step may be performed concurrently.

In a further embodiment there is provided a decanting barrel for removing a liquid from a catalyst slurry comprising a frame; a barrel body affixed to the frame, the barrel body having a reservoir therein and the barrel body including at least one perforated portion; a barrel base affixed to at least one of the frame and the barrel body; and an evacuation conduit having a conduit distal end terminating proximal to the barrel base. The at least one perforated portion of the barrel body may be in fluid communication with the reservoir, and the reservoir may be in fluid communication with the evacuation conduit.

### BRIEF DESCRIPTION OF THE DRAWINGS

FIG. 1 is a block diagram schematically representing apparatus and a process for rapidly removing liquid from a catalyst slurry, according to an embodiment of the present invention;

FIGS. 2A and 2B schematically represent a water decanting barrel for removing liquid from a catalyst slurry in relation to a container for containing the catalyst slurry, according to an embodiment of the present invention;

FIG. 3A schematically represents a water decanting barrel as seen in side view;

FIG. 3B is a transverse sectional view along the line 3B-3B of FIG. 3A;

FIG. 3C is a longitudinal sectional view along the line 3C-3C of FIG. 3A;

FIG. 3D is a plan view of the water decanting barrel of FIG. 3A, according to an embodiment of the present invention;

FIG. 4A is a side view of a barrel base of a water decanting barrel, according to an embodiment of the present invention;

FIG. 4B is a side view of a barrel base of a water decanting barrel in relation to the base of a container, according to an embodiment of the present invention;

FIG. 5A-1 is a perspective view of a barrel body of a water decanting barrel showing a plurality of apertures in a perforated portion of the barrel body;

FIG. 5A-2 is an enlarged view of the perforated portion of the barrel body of FIG. 5A-1;

FIG. 5B is an enlarged view of the perforated portion of the barrel body of FIG. 5A-1 showing an adjacent pair of the apertures, according to an embodiment of the present invention;

FIG. 6A is a perspective view schematically representing a frame of a water decanting barrel, according to an embodiment of the present invention;

FIG. 6B is a perspective view schematically representing a water decanting barrel, according to an embodiment of the present invention; and

FIG. 7 is a perspective view schematically representing a water decanting barrel, according to another embodiment of the present invention.

### DETAILED DESCRIPTION

The present invention provides processes and apparatus for handling spent catalyst from a reactor, wherein a liquid may be rapidly and conveniently removed from a slurry of the catalyst using a decanting barrel disposed in a container of the catalyst slurry.

In contrast to prior art apparatus and processes, the present invention allows handling of spent catalyst more rapidly and conveniently, at lower cost, with much shorter reactor downtime, and without using machinery that is prone to mechanical failure. Apparatus as disclosed herein has the added advantages of being available at low cost, easily used and transported, and having very little or no maintenance requirements.

Unless otherwise specified, the recitation of a genus of elements, materials, or other components from which an individual or combination of components or structures can be selected is intended to include all possible sub-generic combinations of the listed components and mixtures thereof. Also, “include” and its variants are intended to be non-limiting, such that recitation of items in a list is not to the exclusion of other like items that may also be useful in the materials, elements, structures, and methods of this invention.

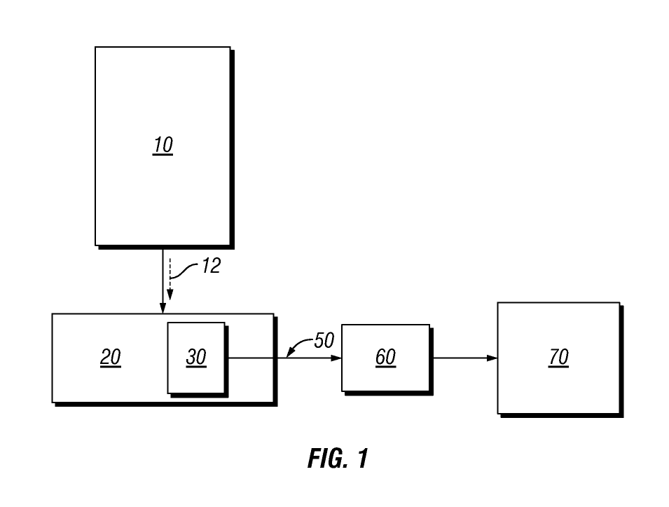

With reference to the drawings, FIG. 1 is a block diagram schematically representing apparatus and processes for rapidly removing a liquid from a catalyst slurry, according to embodiments of the present invention. In an embodiment, a catalyst slurry 12 may be obtained from reactor 10. Reactor 10 may contain spent catalyst that is to be removed from reactor 10 to allow replacement of the spent catalyst with fresh catalyst. In an embodiment, reactor 10 may comprise a hydrocarbon hydroprocessing reactor.

In an embodiment, catalyst slurry 12 may be formed by adding water to reactor 10 such that the water may contact the spent catalyst to form an aqueous slurry of the spent catalyst. In an embodiment, catalyst slurry 12 may comprise the liquid and a plurality of catalyst particles. In an embodiment, catalyst slurry 12 may further comprise catalyst support media (e.g., catalytically inert support balls) that may be used for supporting and stabilizing one or more catalyst beds in reactor 10.

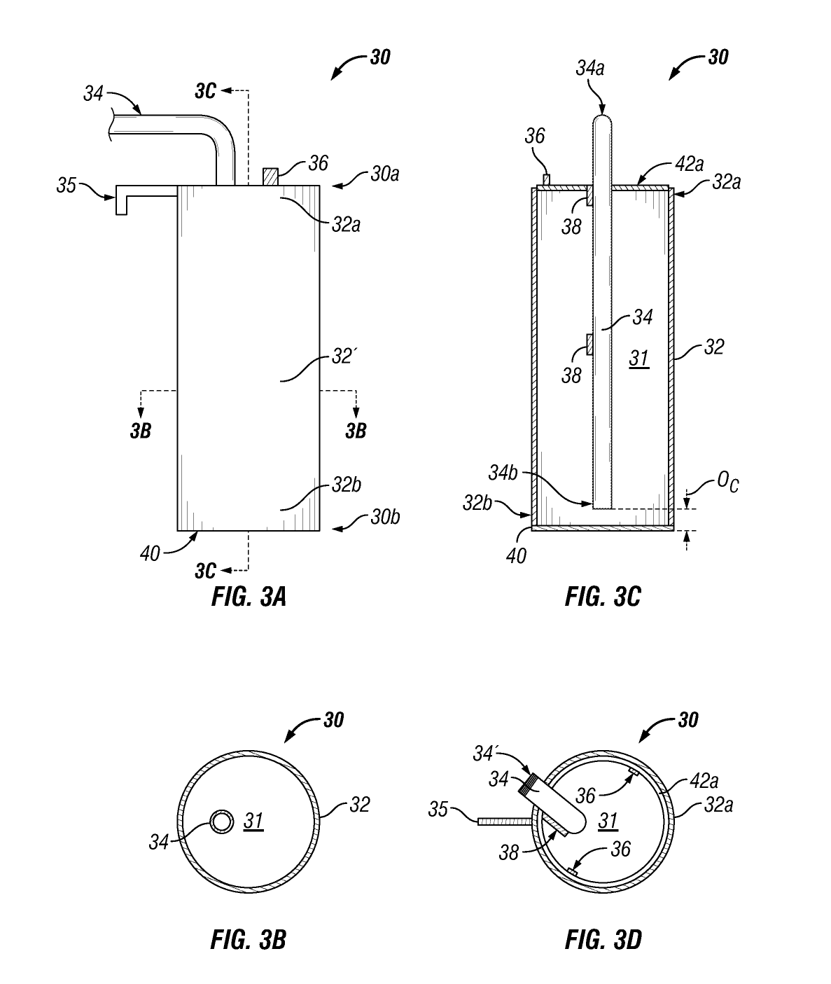

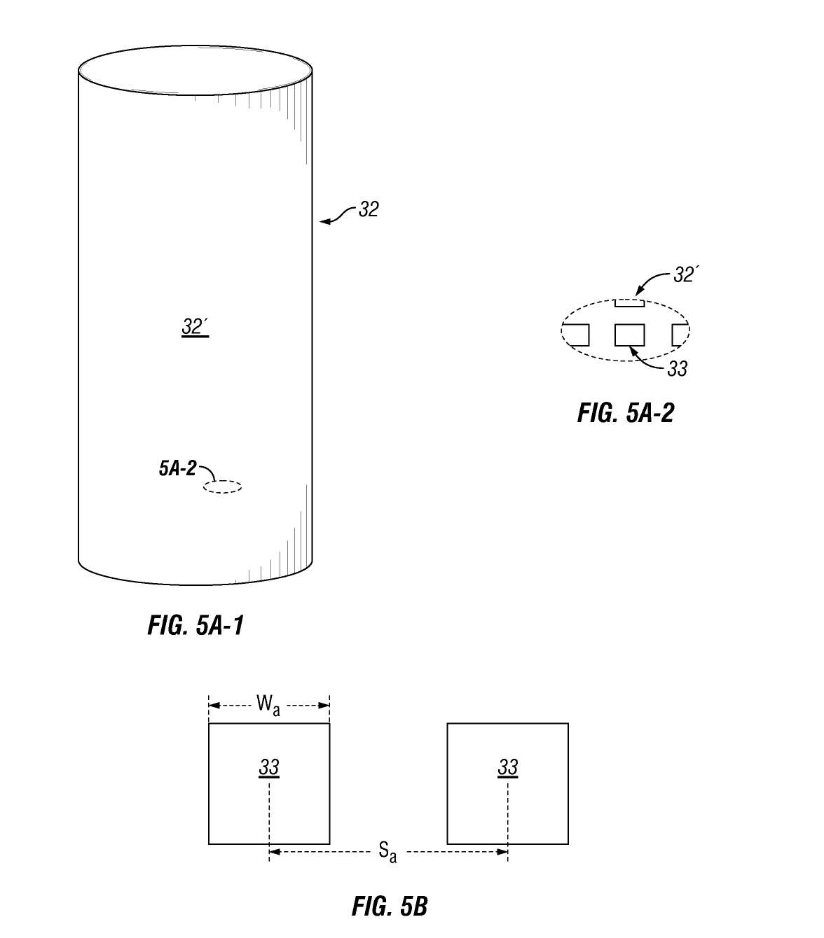

A process for removing liquid from catalyst slurry 12 may comprise disposing a decanting barrel 30 in a container 20. Decanting barrel 30 may include a barrel body 32 having a reservoir 31. Barrel body 32 may include at least one perforated portion 32′ (see, for example, FIGS. 5A and 5B). Perforated portion(s) 32′ of barrel body 32 may be in fluid communication with reservoir 31 (see, for example, FIGS. 3A-3D). In an embodiment, barrel body 32 may define reservoir 31 of decanting barrel 30. In an embodiment, decanting barrel 30 may further include an evacuation conduit 34. Evacuation conduit 34 may be in fluid communication with reservoir 31 (see, for example, FIG. 3C).

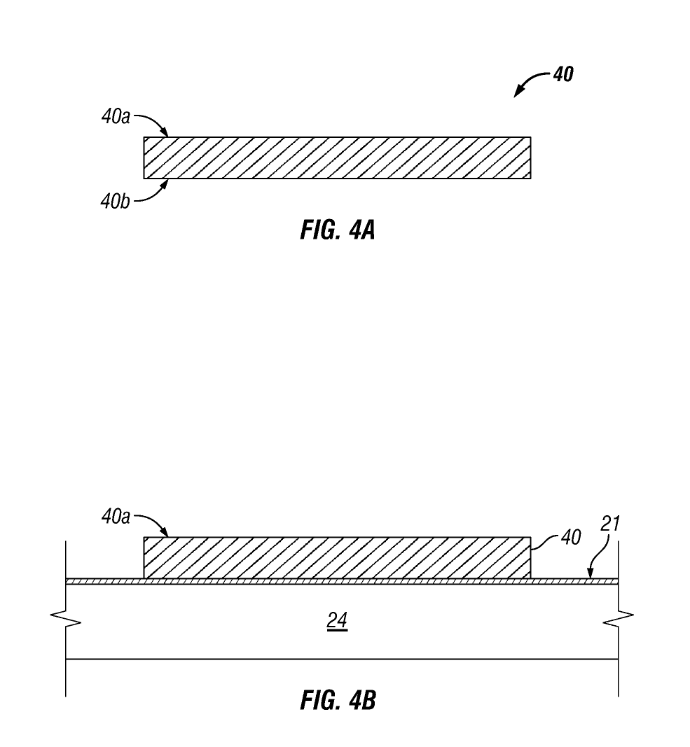

In an embodiment, a process for removing a liquid from catalyst slurry 12 may further include disposing a liner 21 in container 20 (see, for example, FIG. 4B). In an embodiment, liner 21 may be disposed in container 20 prior to the step of disposing decanting barrel 30 in container 20, e.g., such that liner 21 is disposed beneath decanting barrel 30. In an embodiment, liner 21 may comprise plastic sheeting, e.g., comprising polyethylene.

A process for removing a liquid from catalyst slurry 12 may further include adding catalyst slurry 12 to container 20. In an embodiment, catalyst slurry 12 may be added to container 20 such that catalyst slurry 12 contacts perforated portion(s) 32′ of barrel body 32. A process for removing liquid from catalyst slurry 12 may still further include transferring the liquid, via perforated portion 32′, from catalyst slurry 12 to reservoir 31 of decanting barrel 30. In an embodiment, the liquid may be transferred from catalyst slurry 12 to reservoir 31 via perforated portion 32′ under hydrostatic pressure.

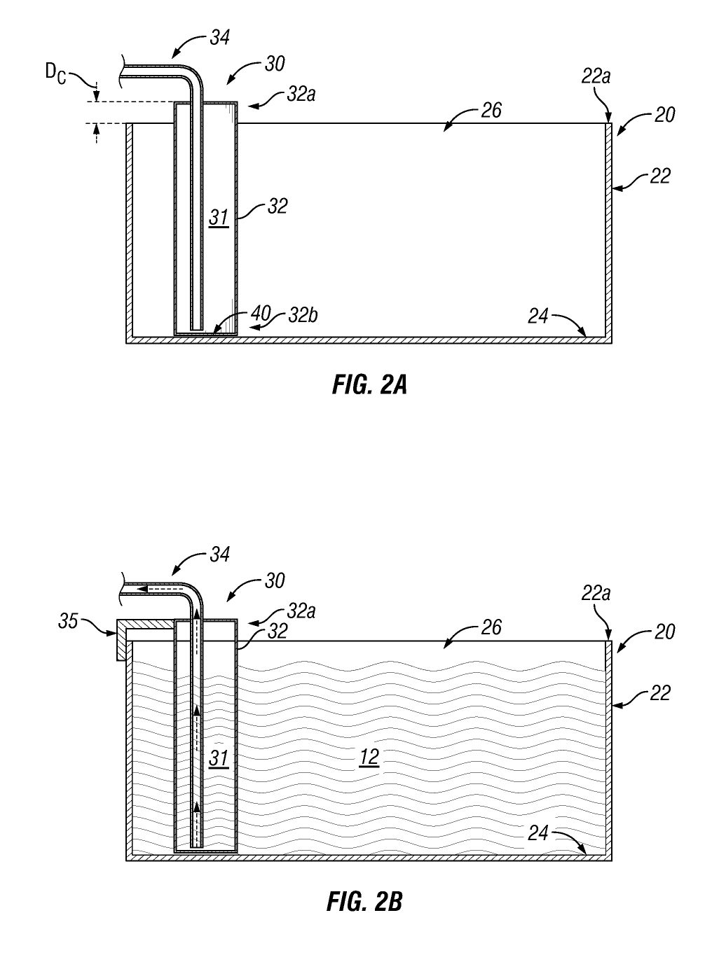

A process for removing liquid from catalyst slurry 12 may further include stabilizing decanting barrel 30 in container 20. In an embodiment, decanting barrel 30 may be stabilized in container 20 in an upright or vertical position. In an embodiment, decanting barrel 30 may include a stabilizer bracket 35 (see, for example, FIGS. 2B and 3A). In an embodiment, decanting barrel 30 may be stabilized in container 20 by coupling or affixing stabilizer bracket 35 to a container wall 22 (see, for example, FIG. 2B). In an embodiment, barrel 30 may be stabilized in container 20 prior to the step of adding catalyst slurry 12 to container 20. In an embodiment, container 20 may have a capacity typically in the range from about 10 cubic yards to 40 cubic yards. In a sub-embodiment, container 20 may comprise a roll-off box.

In an embodiment, an evacuation hose 50 may be coupled to conduit proximal end 34a such that evacuation hose 50 may be in fluid communication with evacuation conduit 34 and reservoir 31. In an embodiment, evacuation hose 50 may be coupled to conduit proximal end 34a prior to the step of adding catalyst slurry 12 to container 20. In an embodiment, conduit proximal end 34a may be configured for the facile coupling of evacuation hose 50 thereto.

A process for removing liquid from catalyst slurry 12 may still further include removing the liquid from reservoir 31 via evacuation conduit 34. In an embodiment, the liquid may be removed from reservoir 31 in a proximal direction through evacuation conduit 34. In an embodiment, the step of removing the liquid from reservoir 31 may be performed concurrently with the step of transferring the liquid from catalyst slurry 12 to reservoir 31.

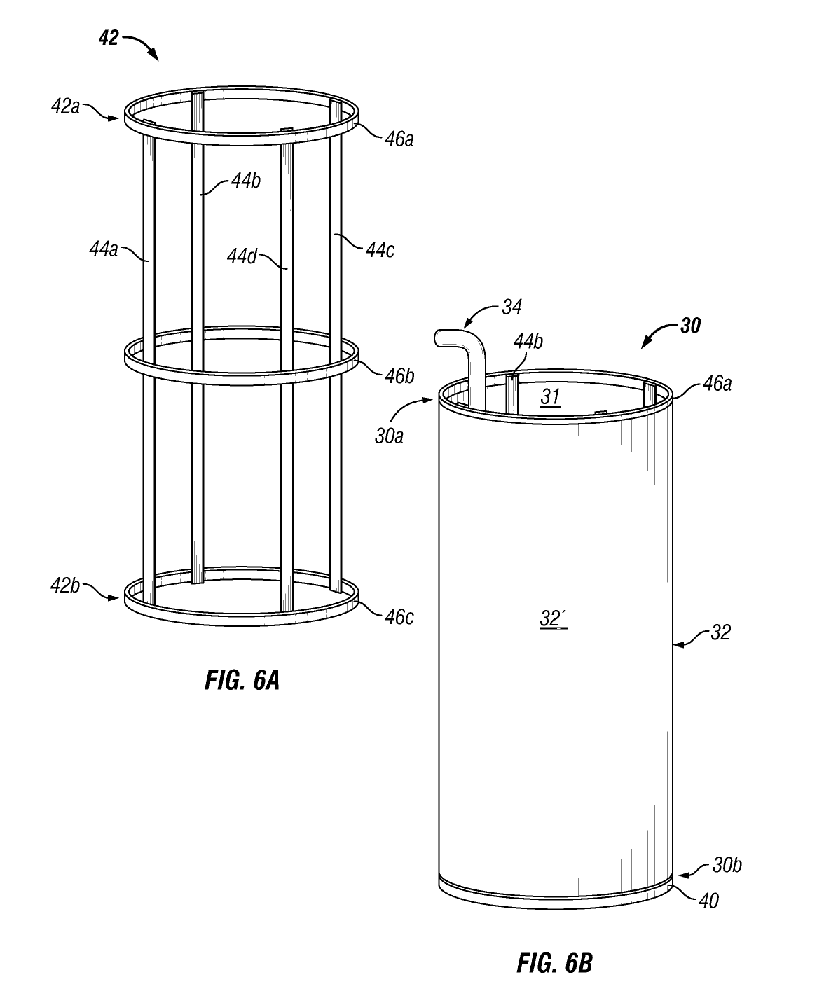

A process for removing liquid from catalyst slurry 12 may further comprise coupling evacuation hose 50 to a pump 60. In an embodiment, evacuation hose 50 may be coupled to pump 60 prior to the step of adding catalyst slurry 12 to container 20. In an embodiment, the liquid may be removed from reservoir 31 by pumping the liquid upwards, e.g., vertically, through evacuation conduit 34, via pump 60, from reservoir 31. Decanting barrel 30 may have an open proximal end 30a and, during the step of removing the liquid from reservoir 31, reservoir 31 may be open to the atmosphere (see, for example, FIG. 6B).

As a non-limiting example, pump 60 may comprise a booster pump or a vacuum pump, and the like. In an embodiment, pump 60 may be a variable speed pump. In an embodiment, pump 60 may be throttleable. In an embodiment, a rate of removing the liquid from reservoir 31 via pump 60 may be controlled by controlling the speed at which pump 60 operates. In an embodiment, the rate at which the liquid is removed from reservoir 31 via pump 60 may be controlled or adjusted, e.g., by an operator, according to the rate at which the liquid is transferred from catalyst slurry 12 to reservoir 31. In an embodiment, a process for removing liquid from catalyst slurry 12 may comprise pumping the liquid, e.g., via pump 60, from reservoir 31 to a liquid storage tank 70.

After a container load of catalyst slurry 12 has been dewatered as disclosed herein, decanting barrel 30 may be removed from container 20 for placement of barrel 30 in a fresh container 20 for dewatering a subsequent aliquot of catalyst slurry 12. In an embodiment, decanting barrel 30 may be removed from container 20 by lifting barrel 30 via one or more lifting lugs 36 (see, for example, FIGS. 3A and 3D).

FIGS. 2A and 2B schematically represent a water decanting barrel for removing liquid from a catalyst slurry in relation to a container for containing the catalyst slurry, according to an embodiment of the present invention. With reference to FIGS. 2A and 2B, container 20 may include container walls 22 and a container base 24. In an embodiment, container walls 22 may be at least substantially vertical and at least substantially orthogonal to container base 24. Container walls 22 may terminate proximally at a container rim 22a. In an embodiment, container walls 22 may have a height, or distance from container base 24 to container rim 22a, in the range from about 3 ft to 6 ft.

In an embodiment, container base 24 may be at least substantially horizontal. In an embodiment, container 20 may be transportable. Container 20 may be disposed at a location with respect to reactor 10 for conveniently adding catalyst slurry 12 to container 20 from reactor 10. In an embodiment, a step of adding catalyst slurry 12 to container 20 may comprise feeding catalyst slurry 12, via gravity, into container 20 from reactor 10. In an embodiment, catalyst slurry 12 may be added to container 20 so as to substantially fill container 20, wherein the level of catalyst slurry 12 may be below the level of container rim 22a. The flow of catalyst slurry 12 from reactor 10 to container 20 may be controlled by one or more valves known in the art. The term “gravity” may be used herein to refer to ambient gravity or approximately Earth's gravity, 1 g.

In an embodiment, decanting barrel 30 may be disposed upright, e.g., at least substantially vertically, in container 20. In an embodiment, decanting barrel 30 may be stabilized in container 20, e.g., via stabilizer bracket 35. In an embodiment, body proximal end 32a may extend above container rim 22a. As a non-limiting example, body proximal end 32a may extend a distance, Dₑ, above container rim 22a (FIG. 2A), wherein Dₑ may be in the range from about 3 inches to 12 inches, or from about 4 inches to 9 inches.

In an embodiment, decanting barrel 30 may include a planar barrel base 40. Decanting barrel 30 may be disposed in container 20 such that barrel base 40 is parallel to container base 24. In an embodiment, container 20 may have a liner 21 disposed therein (see, for example, FIG. 4B). Liner 21 may comprise plastic (e.g., polyethylene) sheeting, such as Visqueen™.

Liner 21 may be disposed in container 20 prior to disposing decanting barrel 30 in container 20. Barrel base 40 may be adapted or configured so as to avoid any damage to liner 21, e.g., such that barrel base 40 does not puncture liner 21.

In an embodiment, liner 21 may have an area greater than the area of the interior of container 20. Liner 21 may be disposed in container 20 so as to provide some degree of slack in liner 21. A portion of liner 21 may be disposed on container base 24 such that there is little or no strain exerted on liner 21 by decanting barrel 30. Accordingly, any risk of damage to liner 21 by barrel 30 is minimized Liner 21 may extend up container walls 22 to a location above (i.e., higher than) the level of catalyst slurry 12 disposed in container 20. In an embodiment, liner 21 may be used to contain catalyst slurry 12 in container 20 so as to avoid any leakage of liquid or catalyst slurry 12 from container 20.

In an embodiment, the liquid present in catalyst slurry 12 may be transferred from catalyst slurry 12 through perforated portion 32′ of barrel body 32 to reservoir 31 by hydrostatic pressure. As noted hereinabove with reference to FIG. 1, in an embodiment liquid may be removed from reservoir 31 via evacuation conduit 34 in a proximal direction, i.e., against the force of gravity, as indicated by the arrows in FIG. 2B. Although FIGS. 2A and 2B show only one decanting barrel 30 in container 20, in a sub-embodiment more than one barrel 30 may be disposed concurrently in a single container 20.

In an embodiment, container 20 may have an open top 26. In an embodiment, catalyst slurry 12 may be added to container 20 by feeding catalyst slurry 12, e.g., from reactor 10, into container 20 via open top 26 of container 20. In an embodiment, container 20 may comprise a transportable metal box. In an embodiment, container 20 may be used to contain, and optionally to transport, dewatered spent catalyst produced by dewatering catalyst slurry 12.

Evacuation conduit 34 may terminate distally within reservoir 31 at a conduit distal end 34b. As can be seen for example from FIG. 3C, conduit distal end 34b may be disposed proximal to barrel base 40. In an embodiment, conduit distal end 34b may terminate at a location proximal to barrel base 40 such that conduit distal end 34b may be offset from barrel base 40 by a distance, O_{b}, wherein O_{b} may be in the range from about 0.75 inch to 2.5 inches, or from about 1.0 inch to 2.25 inches. In an embodiment, the rate at which the liquid is removed from reservoir 31 may be controlled or adjusted such that the level of liquid in reservoir 31 is not less than the distance, O_{b}. In a sub-embodiment, during the liquid removing step, the level of liquid in reservoir 31 may be maintained above the level of conduit distal end 34b. In an embodiment, conduit distal end 34b may be disposed orthogonal to barrel base 40.

In an embodiment, evacuation conduit 34 may have a diameter in the range from about 2.0 inches to 4.0 inches, or from about 2.5 inches to 3.5 inches. In an embodiment, conduit proximal end 34a may be configured for coupling evacuation hose 50 thereto. In an embodiment, conduit proximal end 34a may be threaded. In an embodiment, evacuation hose 50 may be coupled to conduit proximal end 34a via a Camlock fitting or a cam and groove coupling, as is known in the art. In an embodiment, evacuation hose 50 may be coupled to conduit proximal end 34a prior to the step of adding catalyst slurry 12 to container 20. In an embodiment, evacuation hose 50 may have a diameter in the range from about 2.0 inches to 4.0 inches, or from about 2.5 inches to 3.5 inches.

Catalyst slurry 12 may comprise the liquid to be removed from catalyst slurry 12 and a plurality of catalyst particles. The liquid to be removed from catalyst slurry 12 may be aqueous, e.g., the liquid may comprise at least about 99 vol % water. In an embodiment, a volume of catalyst slurry 12 to be dewatered, e.g., during a reactor turnaround operation, may generally comprise at least about 100,000 liters. In an embodiment, the catalyst particles in catalyst slurry 12 may comprise pellets of a hydrocarbon hydroprocessing catalyst obtained from reactor 10.

In an embodiment, catalyst slurry 12 may have a solids content generally in the range from about 10 wt % to 50 wt %. In an embodiment, at least about 99% by weight of the catalyst particles of catalyst slurry 12 may have a particle size in the range from about 0.06 inch to 1.25 inches. As an example, those catalyst particles of catalyst slurry 12 having a particle size range from about 0.06 inch to 1.25 inches may represent at least about 99% by weight of the total weight of the catalyst particles for a given volume of catalyst slurry 12.

In an embodiment, barrel body 32 may exclude at least about 99% by weight of the catalyst particles of catalyst slurry 12 from reservoir 31. As an example, those catalyst particles of catalyst slurry 12 having a particle size sufficiently large to be excluded from reservoir 31 by barrel body 32 may represent at least about 99% by weight of the total weight of the catalyst particles for a given volume of catalyst slurry 12.

FIG. 3A schematically represents a water decanting barrel as seen in side view; FIG. 3B is a transverse sectional view along the line 3B-3B of FIG. 3A; FIG. 3C is a longitudinal sectional view along the line 3C-3C of FIG. 3A; and FIG. 3D is a plan view of the water decanting barrel of FIG. 3A, according to an embodiment of the present invention.

With reference to FIGS. 3A-D, decanting barrel 30 may include a barrel body 32, a barrel base 40, and an evacuation conduit 34 having a conduit proximal end 34a and a conduit distal end 34b. In an embodiment, barrel body 32 may be formed from metal (e.g., carbon steel or stainless steel) plate. In an embodiment, barrel body 32 may be formed from steel plate in the range from about 13 gauge to 22 gauge, or from about 14 gauge to 18 gauge.

Barrel body 32 may include a body proximal end 32a, a body distal end 32b, and at least one perforated portion 32′. In an embodiment, perforated portion(s) 32′ may occupy at least about 50% of the total area of barrel body 32, or at least about 75% of the total area of body 32, or at least about 98% of the total area of body 32. In an embodiment, perforated portion(s) 32′ of body 32 may extend from body distal end 32b to body proximal end 32a. Barrel body 32 may have a reservoir 31 disposed therein. Perforated portion(s) 32′ may be in fluid communication with reservoir 31, and evacuation conduit 34 may be in fluid communication with reservoir 31. In an embodiment, reservoir 31 may extend from body distal end 32b to body proximal end 32a. In an embodiment, reservoir 31 may be jointly defined by barrel body 32 and barrel base 40.

Barrel body 32 may be affixed to a frame 42 (see, for example, FIGS. 6A and 6B). Barrel base 40 may be affixed to at least one of frame 42 and body 32. In an embodiment, decanting barrel 30 may further comprise at least one lifting lug 36 (see, for example, FIG. 3A). Each lifting lug 36 may be affixed to at least one of body proximal end 32a and frame proximal end 42a. In an embodiment, decanting barrel 30 may comprise a pair of diametrically opposed lifting lugs 36 affixed to frame proximal end 42a (see, for example, FIG. 3D). As a non-limiting example, various elements and components of decanting barrel 30, such as frame 42, body 32, barrel base 40, and lifting lug(s) 36, may be affixed to each other using various types of welding known in the art.

Lifting lug(s) 36 may be configured for lifting decanting barrel 30. As an example, decanting barrel 30 may be lifted from container 20 via lifting lug(s) 36 after catalyst slurry 12 has been dewatered in container 20 by decanting barrel 30. In an embodiment, each lifting lug 36 may have a hole or void therein, e.g., for the insertion of a lifting component (not shown) therethrough for lifting barrel 30. In an embodiment, lifting lugs 36 may be employed for lifting decanting barrel 30 by a forklift truck, or the like.

In an embodiment, decanting barrel 30 may have a height in the range from about 3.5 ft to 6 ft, or from about 4 ft to 5.5 ft. In an embodiment, barrel body 32 may extend along at least about 90% of the total length of decanting barrel 30, or at least about 95% of the total length of barrel 30, or at least about 98% of the total length of barrel 30. In an embodiment, barrel body 32 may define a substantially cylindrical void comprising reservoir 31. It is to be understood, however, that decanting barrel 30 and barrel body 32 are not limited to any particular size, shape or configuration, and that barrel body 32 may also be formed according to the instant invention in various shapes other than cylindrical.

In an embodiment, evacuation conduit 34 may be rigid. As a non-limiting example, evacuation conduit 34 may comprise a solid metal (e.g., steel) pipe, or the like. In an embodiment, evacuation conduit 34 may have a diameter in the range from about 2.0 inches to 4.0 inches, or from about 2.5 inches to 3.5 inches. In an embodiment, evacuation conduit 34 may be disposed eccentrically within body 32. In an embodiment, evacuation conduit 34 may be affixed to at least one of body 32 and frame 42, e.g., by one or more bracing straps 38. As a non-limiting example, evacuation conduit 34 may be affixed to body 32 and/or frame 42 via a pair of bracing straps 38 (see, for example, FIGS. 3C and 3D). In an embodiment, at least one bracing strap 38 may be affixed to frame proximal end 42a.

A proximal portion of evacuation conduit 34 may extend proximally beyond (i.e., above) body proximal end 32a, while the remainder of evacuation conduit 34 may be disposed within body 32. In an embodiment, conduit proximal end 34a may be configured for coupling evacuation hose 50 thereto. In an embodiment, conduit proximal end 34a may include a threaded portion 34′. In an embodiment, evacuation hose 50 may be coupled to conduit proximal end 34a via a Camlock fitting or a cam and groove coupling, as is known in the art. In an embodiment, conduit proximal end 34a may be bent or curved. In a sub-embodiment, conduit proximal end 34a may be bent at an angle of about 90°, e.g., such that threaded portion 34′ may be disposed at least substantially horizontally.

In an embodiment, decanting barrel 30 may further comprise a stabilizer bracket 35. Stabilizer bracket 35 may be used for stabilizing decanting barrel 30, e.g., in an upright position in container 20, for example as shown in FIGS. 2A and 2B. In an embodiment, stabilizer bracket 35 may be affixed to barrel proximal end 30a. In a sub-embodiment, stabilizer bracket 35 may be affixed to at least one of frame proximal end 42a and body proximal end 32a. In an embodiment, stabilizer bracket 35 may be configured for the facile connection to, and disconnection from, container wall 22 (see, for example, FIG. 2B). In an embodiment, stabilizer bracket 35 may comprise angle iron, or the like. The invention is not limited to any particular type, shape, or configuration for stabilizer bracket 35.

FIG. 4A is a side view of a barrel base of a water decanting barrel, according to an embodiment of the present invention. Barrel base 40 may have a base upper surface 40a and a base lower surface 40b. In an embodiment, barrel base 40 may be planar. As an example, base lower surface 40b may be essentially two dimensional and lie in a single plane.

FIG. 4B is a side view of barrel base 40 of decanting barrel 30 in relation to a portion of container 20, according to an embodiment of the present invention. Barrel base 40 may be disposed parallel to container base 24. Both barrel base 40 and container base 24 may be disposed horizontally both before and after the addition of catalyst slurry 12 to container 20. In an embodiment, a liner 21 may be disposed on container base 24 such that liner 21 is disposed between barrel base 40 and container base 24. In an embodiment, liner 21 may comprise plastic sheeting, e.g., comprising polyethylene.

In an embodiment, barrel base 40 may be configured so as to minimize the risk of damage to liner 21. In an embodiment, base lower surface 40b may be flat and smooth, e.g., base lower surface 40b may lack any protuberances or irregularities that could potentially puncture liner 21. In an embodiment, barrel base 40 may be disposed distal to barrel body 32. In an embodiment, base lower surface 40b may represent the most distal portion of decanting barrel 30.

FIG. 5A-1 is a perspective view of barrel body 32 of decanting barrel 30 showing a plurality of apertures 33 in a perforated portion 32′ of barrel body 32, according to an embodiment of the present invention. During a liquid transferring step of a catalyst dewatering process as disclosed herein, wherein liquid may be transferred from catalyst slurry 12 to reservoir 31 via perforated portion 32′, barrel body 32 including perforated portion 32′ may be disposed upright or vertically in container 20.

In an embodiment, perforated portion 32′ may extend longitudinally to occupy at least about 50% of the total length of barrel body 32, or at least about 75% of the total length of body 32, or at least about 98% of the total length of body 32. In an embodiment, perforated portion 32′ may extend laterally or circumferentially around at least about 50% of the circumference of barrel body 32, or at least about 75% of the circumference of body 32, or at least about 98% of the circumference of body 32. In an embodiment, perforated portion 32′ may occupy at least about 50% of the total area of barrel body 32, or at least about 75% of the total area of body 32, or at least about 98% of the total area of body 32.

In an embodiment, barrel body 32, including perforated portion 32′, may be formed from carbon steel plate or stainless steel plate. In an embodiment, perforated portion 32′ of barrel body 32 may comprise perforated metal plate having a plurality of apertures 33 therein. In an embodiment, barrel body 32, including perforated portion 32′, may be formed from steel plate in the range from about 13 gauge to 22 gauge, or from about 14 gauge to 18 gauge. In an embodiment, perforated portion 32′ may be sectional. For example, perforated portion 32′ may comprise two or more sections of perforated plate or the like. In an embodiment, each such section of perforated portion 32′ may be affixed to frame 42.

FIG. 5B is an enlarged view of perforated portion 32′ of barrel body 32 showing an adjacent pair of apertures 33, according to an embodiment of the present invention. In an embodiment, each aperture 33 may have a width, Wₐ, in the range from about 0.04 inch to 0.15 inch, or from about 0.04 inch to 0.125 inch. In an embodiment, the centers of adjacent apertures 33 may be spaced apart by a spacing distance, Sₐ, in the range from about 0.08 inch to 0.30 inch, or from about 0.08 inch to 0.25 inch. In an embodiment, perforated portion 32′ may have an open area in the range from about 10% to 70%, or from about 15% to 60%, or from about 20% to 50%. Although apertures 33, for example as shown in FIG. 5B, may appear substantially square in outline, other shapes and configurations for apertures 33 are also within the scope of the instant invention.

FIG. 6A is a perspective view schematically representing a frame 42 of a decanting barrel 30, according to an embodiment of the present invention. Frame 42 may have a frame proximal end 42a and a frame distal end 42b. In an embodiment, frame 42 may be formed from flat bar comprising steel. In an embodiment, flat bar comprising frame 42 may have a thickness, for example, in the range from about 0.15 inch to 0.35 inch, and a width, for example, in the range from about 1.25 inch to 2.5 inch.

In an embodiment, frame 42 may comprise a plurality of longitudinal members 44a-d. In an embodiment, frame 42 may further comprise a plurality of lateral members 46a-c. In an embodiment, each of lateral members 46a-c may be affixed to at least two of longitudinal members 44a-d. In a sub-embodiment, each of lateral members 46a-c may be affixed to each of longitudinal members 44a-d. In an embodiment, each of longitudinal members 44a-d may be linear. In an embodiment, each of lateral members 46a-c may be circular. In an embodiment, each of lateral members 46a-c and longitudinal members 44a-d may comprise steel flat bar.

FIG. 6B is a perspective view schematically representing a water decanting barrel 30, according to an embodiment of the present invention. Decanting barrel 30 may comprise barrel body 32 and barrel base 40. At least part of barrel body 32 may be perforated, for example to provide perforated portion 32′, as disclosed hereinabove, e.g., with reference to FIGS. 5A and 5B. Barrel body 32 may be affixed to lateral members 46a-c and/or to longitudinal members 44a-d of frame 42. In an embodiment, barrel base 40 may be affixed to frame distal end 42b.

It is to be understood that frame 42 and body 32 are by no means limited to a particular configuration, for example as shown in FIGS. 6A and 6B. Rather, other configurations for frame 42 and body 32 are also possible under the invention. For example, frame configurations having other numbers and arrangements for longitudinal members and/or lateral members are also within the scope of the instant invention.

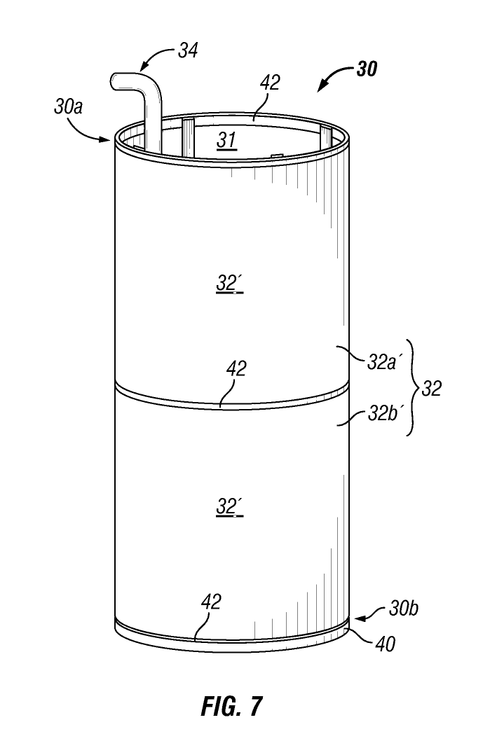

FIG. 7 is a perspective view schematically representing a water decanting barrel according to another embodiment of the present invention. In the embodiment of FIG. 7, body 32 may comprise a proximal body section 32a′ and a distal body section 32b′. Each of proximal body section 32a′ and distal body section 32b′ may be affixed to frame 42. As a non-limiting example, each of proximal body section 32a′ and distal body section 32b′ may be stitch welded to frame 42. In an embodiment, each of proximal body section 32a′ and distal body section 32b′ may comprise a perforated portion 32′, e.g., as described with reference to FIGS. 5A-B.

### EXAMPLES

The following Examples illustrate, but do not limit, the invention.

### Example 1

Comparison of a Decanting Barrel (Invention) with a Classifier (Prior Art) for Dewatering a Container of Spent Catalyst Slurry

Using a classifier (auger) of the prior art, one roll-off box (10 cubic yards capacity) of the catalyst slurry was dewatered in an average time of about 40 minutes. Using a decanting barrel, according to embodiments of the instant invention, the average time required to dewater a 10 cubic yard roll-off box of the catalyst slurry was decreased to about 11 minutes, representing a saving of about 29 minutes per load (10 cubic yards, or about 7,600 liters, of the catalyst slurry).

### Example 2

Comparison of a Decanting Barrel (Invention) with a Classifier (Prior Art) for Wet Dumping Spent Catalyst from One Reactor

Water was fed into a hydrocarbon hydroprocessing reactor containing pellets of spent catalyst to yield sufficient catalyst slurry to fill 15 to 20 roll-off boxes of the size described in Example 1. The roll-off boxes were dewatered sequentially using a single decanting barrel per container load, according to embodiments of the instant invention. The total time required to dewater the catalyst slurry from the reactor using the decanting barrel was about 10 hours (i.e., considerably less than one 12-hr shift).

In contrast, using a classifier of the prior art took about 36 hours (i.e., equivalent to three 12-hr shifts) to dewater an equivalent volume of catalyst slurry from the same reactor.

It can be seen from Examples 1 and 2 that the invention allows for much faster reactor turnarounds when replacing spent catalyst, thereby greatly increasing efficiency and reducing turnaround costs.

Numerous variations of the present invention may be possible in light of the teachings and examples herein. It is therefore understood that within the scope of the following claims, the invention may be practiced otherwise than as specifically described or exemplified herein.

What is claimed is:

1. A process for removing a liquid from a catalyst slurry, the process comprising:
a) disposing a decanting barrel in a container, wherein the decanting barrel includes a barrel body having at least one perforated portion;
b) adding the catalyst slurry to the container such that the catalyst slurry contacts the at least one perforated portion of the barrel body, wherein the catalyst slurry comprises the liquid and a plurality of catalyst particles;
c) via the at least one perforated portion of the barrel body, transferring the liquid from the catalyst slurry to a reservoir of the decanting barrel; and
d) removing the liquid from the reservoir in a proximal direction.

2. The process according to claim 1, wherein:
the decanting barrel further includes an evacuation conduit in fluid communication with the reservoir, and
step d) comprises pumping the liquid upwards through the evacuation conduit from the reservoir.

3. The process according to claim 1, wherein during step c) the at least one perforated portion of the barrel body is disposed upright in the container.

4. The process according to claim 1, further comprising:
e) during step d), controlling the rate at which the liquid is removed from the reservoir according to the rate at which the liquid is transferred from the catalyst slurry to the reservoir.

5. The process according to claim 1, wherein:
the decanting barrel further includes a barrel base and an evacuation conduit having a conduit distal end, and
the conduit distal end terminates at a location about 0.75 inch to 2.5 inches proximal to the barrel base.

6. The process according to claim 1, wherein:
the decanting barrel further includes an evacuation conduit having a conduit proximal end,
the evacuation conduit is in fluid communication with the reservoir, and the process further comprises:
f) prior to step b), coupling an evacuation hose to the conduit proximal end.

7. The process according to claim 1, wherein the barrel body excludes at least about 99% by weight of the catalyst particles from the reservoir.

8. The process according to claim 1, wherein the catalyst particles comprise pellets of a hydrocarbon hydroprocessing catalyst.

9. The process according to claim 1, wherein:
the decanting barrel further includes a barrel base,
the container includes a container base,
the container base is horizontal, and
step a) comprises disposing the decanting barrel in the container such that the barrel base is parallel to the container base.

10. The process according to claim 1, further comprising:
g) prior to step b), stabilizing the decanting barrel in an upright position in the container.

11. The process according to claim 1, wherein:
the container has an open top, and
step b) comprises feeding the catalyst slurry from a reactor into the container via the open top of the container, and the process further comprises:
h) after step d), lifting the decanting barrel from the container.

12. A process for removing a liquid from a catalyst slurry, the process comprising:
a) disposing a decanting barrel in a container, wherein the decanting barrel includes an evacuation conduit and a barrel body having at least one perforated portion;
b) adding the catalyst slurry to the container, wherein the catalyst slurry comprises the liquid and a plurality of catalyst particles;
c) via the at least one perforated portion of the barrel body, transferring the liquid from the catalyst slurry to a reservoir of the decanting barrel; and
d) pumping the liquid from the reservoir through the evacuation conduit, wherein:
the reservoir is disposed within the barrel body,
the reservoir is in fluid communication with the at least one perforated portion of the barrel body,
the evacuation conduit is in fluid communication with the reservoir,
the decanting barrel further includes a planar barrel base,
the evacuation conduit has a conduit distal end terminating at a location proximal to the barrel base,
step b) comprises feeding the catalyst slurry to the container from a hydrocarbon hydroprocessing reactor,
the catalyst particles comprise pellets of a hydrocarbon hydroprocessing catalyst,
during step c) the at least one perforated portion of the barrel body is disposed upright in the container, and
step d) is performed concurrently with step c).

13. A decanting barrel, for removing a liquid from a catalyst slurry, comprising:
a frame;
a barrel body affixed to the frame, the barrel body having a reservoir therein and the barrel body including at least one perforated portion;
a barrel base affixed to at least one of the frame and the barrel body; and
an evacuation conduit having a conduit distal end terminating proximal to the barrel base, wherein:
the at least one perforated portion of the barrel body is in fluid communication with the reservoir, and
the reservoir is in fluid communication with the evacuation conduit.

14. The decanting barrel according to claim 13, wherein the conduit distal end terminates within the reservoir at a location about 0.75 inch to 2.5 inches proximal to the barrel base.

15. The decanting barrel according to claim 13, wherein the conduit distal end is disposed orthogonal to the barrel base.

16. The decanting barrel according to claim 13, wherein the evacuation conduit is disposed eccentrically within the barrel body.

17. The decanting barrel according to claim 13, wherein:
the evacuation conduit is rigid, and
the evacuation conduit is affixed to at least one of the barrel body and the frame.

18. The decanting barrel according to claim 13, wherein the barrel base has a smooth, flat lower surface.

19. The decanting barrel according to claim 13, wherein the at least one perforated portion occupies at least about 50% of the total area of the barrel body.

20. The decanting barrel according to claim 13, further comprising at least one lifting lug affixed to at least one of the frame and the barrel body, wherein:
the barrel body defines a substantially cylindrical void comprising the reservoir,
the frame comprises a plurality of longitudinal members and a plurality of lateral members, and
each of the lateral members is affixed to at least two of the longitudinal members.
